(19) United States
(12) Patent Application Publication
(10) Pub. No.: US 2009/0266820 A1
(43) Pub. Date: Oct. 29, 2009

(54) Leaf handling apparatus and method

(76) Inventor: H. Scott Osburn, Richmond, VA (US)

Correspondence Address: Norman B. Rainer, 2008 Fondulac Road, Richmond, VA, 23229, US

(21) Appl. No.: 12/148,751

(22) Filed: Apr. 23, 2008

(51) Int. Cl. B65F 1/06; B65D 25/14; B65D 25/16

(52) U.S. Cl. 220/495.11

(57) ABSTRACT

A method and apparatus are provided for the gathering, transporting and disposal of fallen leaves. The apparatus includes a wheeled container, a compliant bag of open mesh construction configured to removably reside within the container, and a tether cord attached to the bottom of the bag and extending exteriorly of the container. By pulling upon the tether cord, the contents of the bag are discharged as a reasonably compact pile.

### BACKGROUND OF THE INVENTION

1. Field of the Invention

The present invention relates to the gathering of fallen leaves and the transport thereof for the purpose of disposal, and more particularly concerns apparatus involving a wheeled container for the loading, transporting and unloading of fallen leaves.

2. Description of the Prior Art

Leaves that have fallen upon a lawn are generally considered unsightly, and with sufficient accumulation the leaves can smother and kill the underlying grass. Several approaches are well known for simplifying the removal of leaves. In one technique, leaves which have been accumulated into piles by way of raking or a blower apparatus are placed into disposable bags which are then secured and carried off to a site of ultimate disposal or placed at a site from which a municipal or private service truck will pick up the bags for disposal.

The bagging of leaves is a time-consuming and arduous task primarily because of the difficulty in loading the bags with reasonable compaction so as to minimize the number of bags required. Although the entering of the leaves into the bag may be simplified by employing an upright container that confines the bag while keeping its mouth in an open state, compaction of the leaves within the bag becomes a problem.

In many municipalities, leaf removal service is available whereby a vacuuming truck takes away leaves accumulated in piles at curbside. Where such service is available, it is expedient to gather leaves into large wheeled containers, typically of 96 gallon size and then dump the leaves to form said piles at curbside. Such large containers are generally of heavy duty plastic construction to enhance durability. Although the filling of the large containers with leaves is easy, and movement of a filled container to the curb is reasonably effortless, the dumping of the leaves by inverting the container to produce a neat pile can be challenging, especially for frail or elderly people.

Various bagging techniques suitable for the gathering and removal of leaves are disclosed in U.S. patents.

U.S. Pat. No. 4,287,701 discloses a bag holder suitable for leaf collection and having an associated circular coil spring that secures the mouth of a bag around the rim of an upright container. A pull cord is attached to the coil spring to facilitate removal of the filled bag from the container.

Bag-type leaf collecting devices which position the bag horizontally upon the ground to facilitate loading with leaves are disclosed in U.S. Pat. Nos. 4,958,846; 5,031,277; and 5,593,117.

Various vertically oriented systems suitable for the collection of leaves into bags are described in U.S. Pat. Nos. 5,518,137; 5,611,507; 5,690,247; 5,645,186; 6,286,706; and 7,243,811.

None of the aforesaid patents, however, address the issue of dumping unbagged collected leaves for removal purposes.

It is accordingly an object of the present invention to provide apparatus for collecting, transporting and dumping unbagged leaves.

It is another object of this invention to provide apparatus as in the foregoing object which employs a large wheeled container.

It is a further object of the present invention to provide apparatus of the aforesaid nature which minimizes the effort involved in collecting and disposing of fallen leaves.

It is yet another object of this invention to provide apparatus of the aforesaid nature capable of producing a dumped pile of leaves of sufficiently compact size to expedite removal by a vacuum truck.

These objects and other objects and advantages of the invention will be apparent from the following description.

### SUMMARY OF THE INVENTION

The above and other beneficial objects and advantages are accomplished in accordance with the present invention by an apparatus for collecting fallen leaves, transporting said leaves to a remote location, and discharging said leaves upon the ground in an orderly pile, said apparatus comprising:
a) a container of substantially integral plastic construction having an interior region, a bottom portion equipped with at least one pair of exteriorly mounted wheels, a circuitous sidewall portion upwardly emergent from said bottom portion upon a vertical axis and defining front and rear portions of the container and terminating in a rim disposed substantially in a plane orthogonal to said axis, a closure lid adapted to engage said rim, and handle means associated with said rim above said wheels,
b) a compliant bag of open mesh construction fabricated of synthetic fiber and configured to removably reside within said interior region, said bag having a closed lower extremity adapted to rest upon said bottom portion, a length sector dimensioned to abut laterally against said sidewall, and a mouth extremity adapted to engage said rim, thereby maintaining said mouth portion in an open state and defining a leaf-gathering compartment, and
c) tether means attached to the center of the lower extremity of said bag within said compartment and extending over said rim to a distal extremity located exteriorly of said container, whereby,
d) when said container is tipped over, causing its sidewall portion to rest upon the ground, and pulling force is applied to said tether, said bag is caused to discharge its content of leaves.

### BRIEF DESCRIPTION OF THE DRAWING

For a fuller understanding of the nature and objects of the invention, reference should be had to the following detailed description taken in connection with the accompanying drawing forming a part of this specification and in which similar numerals of reference indicate corresponding parts in all the figures of the drawing:

FIG. 1 is a side perspective view of an embodiment of the apparatus of the present invention shown in its upright position for receiving fallen leaves.

FIG. 2 is a top view of the embodiment of FIG. 1.

FIG. 3 is a vertical sectional view taken in the direction of the arrows upon line 3-3 of FIG. 2.

FIG. 4 is a side view of the embodiment of FIG. 1 shown in its transport position.

FIG. 5 is a side view of the embodiment of FIG. 1 with portions broken away shown in its tipped over position for discharging its content of leaves.

FIG. 6 is a fragmentary plan view of the bag component of the apparatus of FIG. 1.

### DESCRIPTION OF THE PREFERRED EMBODIMENT

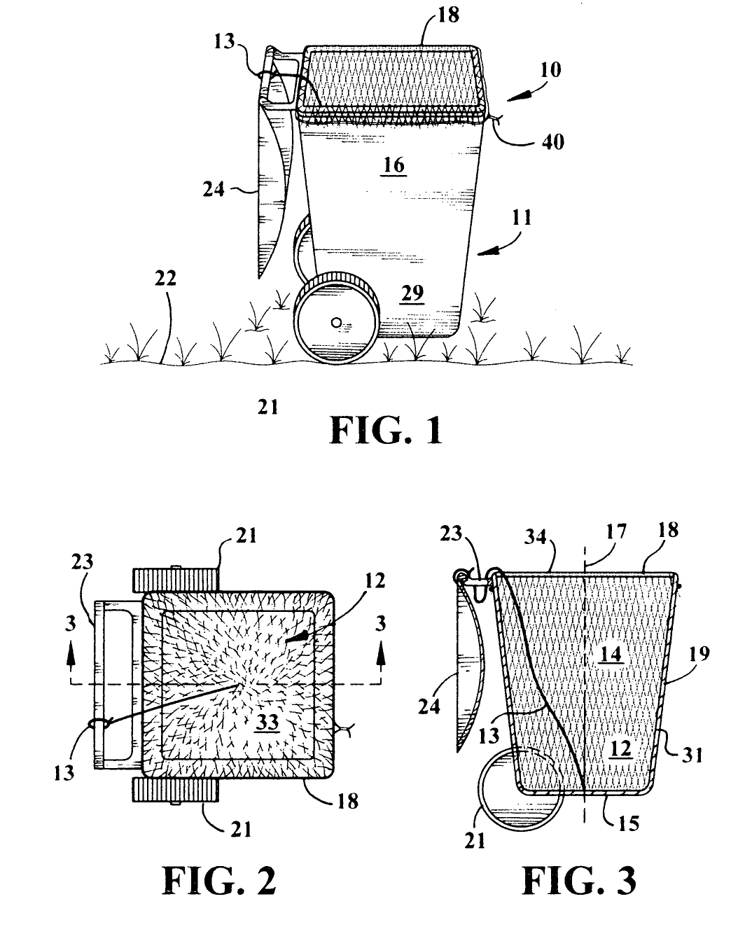

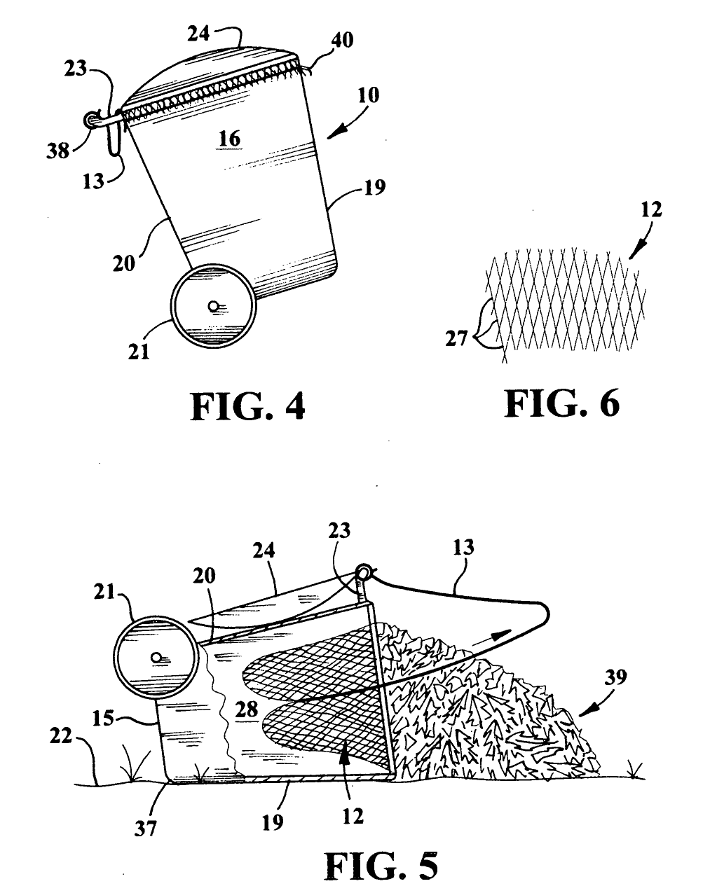

Referring now to FIGS. 1-5, an embodiment of the leaf handling apparatus 10 of the present invention is shown comprised of container 11, compliant bag 12 positioned within said container, and tether means 13 attached to said bag.

Container 11 is of substantially monolithic construction fabricated of heavy gauge plastic such as polyethylene. It has an interior region 14 bounded by bottom portion 15 and circuitous sidewall 16 upwardly emergent from said bottom portion upon vertical axis 17 and terminating in a rim 18 disposed substantially in a plane orthogonal to said axis. Said sidewall defines front and rear portions 19 and 20, respectively of container 11, and is preferably tapered in a downwardly convergent manner, causing the container to be narrower at the bottom portion than at rim 18. Sidewall 16 is further bounded by opposed interior and exterior surfaces 28 and 29, respectively. A pair of exteriorly mounted wheels 21 is located at the lowermost extremity of rear portion 20, thereby enabling the container to roll upon underlying ground surface 22.

An elongated handle bar 23 is attached to rim 18 at the uppermost extremity of rear portion 20. Said handle bar facilitates pulling and pushing of the container upon ground surface 22. A closure lid 24 adapted to interact with rim 18 is shown pivotably associated with handle bar 23.

Bag 12 is of compliant open mesh construction fabricated of synthetic fiber such as polypropylene, polyamide (nylon) and polyester. The open mesh configuration preferably contains diamond-shaped apertures 27 of ⅛″ to ½″ size as shown in FIG. 6. It is preferred that said apertures are elongated in the direction of axis 17. Such orientation enables the bag, when inserted into interior region 14 and filled with leaves, to expand laterally, namely transversely to axis 17, and thereby make a closer fit with interior surfaces 28 of said sidewall.

Bag 12 has a closed lower extremity 30 adapted to rest upon bottom portion 15, a length sector 31 dimensioned to abut laterally against the interior surfaces 28 of said sidewall, and a mouth extremity 34 adapted to engage rim 18, thereby maintaining said mouth in an open state and defining a leaf-gathering compartment 33.

Tether means in the form of rope 13 is attached to the lower extremity of said bag, preferably at the center thereof within compartment 33, and extends to a distal extremity 38 emergent from said compartment and passing over rim 18. Said distal extremity may be secured to handle bar 23 for convenience.

In the method of this invention for leaf gathering, transporting, and dumping, container 11 is initially placed in its vertically upright position with bag 12 emplaced therein, and lid 24 pivoted to its open position. Fallen leaves are then entered into bag 12. Lid 24 is then closed. The container then is tilted so as to rest upon wheels 21, and pushed or pulled to a disposal destination. The container is again placed in upright position, and the lid is opened. Tether rope 13, preferably attached to handle 23 is pulled so as to cause the container to tilt forwardly by pivoted motion about front lower edge 37 acting upon ground surface 22, and continuing until front portion 19 of the container is brought into flush contact with the ground. Further forward pulling of rope 13 advances lower extremity 30 of the bag, causing its leaf content to be discharged upon the ground surface 22 as a reasonably compact pile 39. Such process avoids the need to invert the container with its cargo of leaves, which could weigh up to about 80 pounds, especially if wet. The mouth of the bag remains secured to the rim, thereby facilitating re-insertion of the bag into the container. Said securement of the mouth of the bag is preferably achieved by way of a drawstring 40 associated with the bag and adapted to engage rim 18 of the container.

While particular examples of the present invention have been shown and described, it is apparent that changes and modifications may be made therein without departing from the invention in its broadest aspects. The aim of the appended claims, therefore, is to cover all such changes and modifications as fall within the true spirit and scope of the invention.

Having thus described my invention, what is claimed is:

1) Apparatus for collecting fallen leaves, transporting said leaves to a remote location, and discharging said leaves upon the ground in an orderly pile, said apparatus comprising:
a) a container of substantially integral plastic construction having an interior region, a bottom portion equipped with at least one pair of exteriorly mounted wheels, a circuitous sidewall portion upwardly emergent from said bottom portion upon a vertical axis and defining front and rear portions of the container and terminating in a rim disposed substantially in a plane orthogonal to said axis, a closure lid adapted to engage said rim, and handle means associated with said rim above said wheels,
b) a compliant bag of open mesh construction fabricated of synthetic fiber and configured to removably reside within said interior region, said bag having a closed lower extremity adapted to rest upon said bottom portion, a length sector dimensioned to abut laterally against said sidewall, and a mouth extremity adapted to engage said rim, thereby maintaining said mouth portion in an open state and defining a leaf-gathering compartment, and
c) tether means attached to the center of the lower extremity of said bag within said compartment and extending over said rim to a distal extremity located exteriorly of said container, whereby,
d) when said container is tipped over, causing its sidewall portion to rest upon the ground, and pulling force is applied to said tether, said bag is caused to discharge its content of leaves.

2) The apparatus of claim 1 wherein said sidewall portion is tapered in a downwardly convergent manner, causing said container to be narrower at said bottom portion than at said rim.

3) The apparatus of claim 2 wherein said sidewall portion is bounded by opposed interior and exterior surfaces.

4) The apparatus of claim 3 wherein the open mesh construction of said bag contains diamond-shaped apertures elongated in the direction of said axis, thereby enabling the bag, when inserted into said interior region and filled with leaves, to expand laterally into close fit with the interior surface of said sidewall.

5) The apparatus of claim 4 wherein said tether means is a rope.

6) The apparatus of claim 5 wherein the interior region of said container has a volume greater than 80 gallons.

7) A method for gathering, transporting and dumping leaves comprising:
a) employing the apparatus of claim 1 with said container initially in a vertically upright position with said bag emplaced therein and said lid pivoted to its open position,
b) entering leaves into said bag,
c) closing said lid,
d) tilting said container rearwardly and transporting to a dumping site by rolling upon said wheels, and
e) at said dumping site, pulling upon said tether to cause the container to tilt forwardly until it rests upon said sidewall in contact with the ground surface, and pulling further upon said tether to advance the lower extremity of said bag, and thereby cause the leaf content of said bag to be discharged upon the ground surface as a reasonably compact pile.

8) The apparatus of claim 6 wherein the mouth extremity of said bag is equipped with a drawstring adapted to engage the rim of said container.
